(19) United States
(12) Patent Application Publication
(10) Pub. No.: US 2014/0265672 A1
(43) Pub. Date: Sep. 18, 2014

(54) PHASE LEAD INSULATOR

(71) Applicant: REMY TECHNOLOGIES, LLC, Pendleton, IN (US)

(72) Inventor: Michael D. Bradfield, Anderson, IN (US)

(73) Assignee: Remy Technologies, LLC, Pendleton, IN (US)

(21) Appl. No.: 13/801,908

(22) Filed: Mar. 13, 2013

(51) Int. Cl. H02K 5/22; H02K 15/00

(52) U.S. Cl. CPC H02K 5/225; H02K 15/0068
USPC 310/71; 29/596

(57) ABSTRACT

An alternator includes a phase lead insulator structured for electrically insulating and routing phase leads, the insulator including a channel guide having a width substantially equal to a width of one phase lead, the insulator including a retainer for retaining a phase lead within the channel guide. The phase lead insulator may include a circumferential channel guide having a width substantially equal to a width of a conductor and having a height substantially greater than or equal to a plurality of heights of such conductors and may include a retainer for retaining a conductor within the channel guide. A method of placing phase leads of an alternator includes bending at least one phase lead into the channel guide, and routing phase lead(s) to a corresponding connection position of a bridge rectifier.

### BACKGROUND

The present invention is directed to efficiently and effectively routing stator phase leads from their respective winding locations to termination locations of a rectifier assembly.

An automotive alternator typically includes a rotor assembly that provides a rotating magnetic field, a stator for producing alternating current (AC) electricity when excited by the magnetic field, and a rectifier diode bridge for converting the AC electricity to a direct current (DC). The stator may have any number of phases, and a corresponding number of phase leads for outputting AC to the rectifier diodes. For example, in a given application, a 3φ stator may have 3, 4, 6, or more phase leads, depending on the chosen configuration such as wye or delta and on the wiring thereof.

One or more insulators have conventionally been used for preventing short-circuiting or other unwanted contact with the conductive portion of the phase leads. However, such arrangements may require extra connections between phase leads and respective rectifier bridge locations, may not provide adequate physical support of phase leads that are subjected to vibration and other stress/strain, may not be optimized for efficient use of available space for routing of the phase leads, and may not adequately retain the phase leads.

### SUMMARY

It is therefore desirable to obviate the above-mentioned disadvantages by providing a unique phase lead insulator and method.

According to an exemplary embodiment, an alternator includes a stator core having a plurality of phase windings wound thereon, the windings each having at least one phase lead extending therefrom, an alternator frame for passing ones of the phase leads axially therethrough, and a phase lead insulator structured for electrically insulating the phase leads, the insulator including a channel guide having a width substantially equal to a width of one phase lead and having a height substantially greater than or equal to a plurality of heights of the phase leads, the insulator including a retainer for retaining a phase lead within the channel guide.

According to another exemplary embodiment, a phase lead insulator for electrically insulating phase leads of an alternator includes a circumferential channel guide having a width substantially equal to a width of a conductor of stator windings and having a height substantially greater than or equal to a plurality of heights of such conductors, and includes a retainer for retaining a conductor within the channel guide.

According to a further exemplary embodiment, a method of placing phase leads of an alternator includes providing an insulator for electrically insulating the phase leads, the insulator including a channel guide having a channel width substantially equal to a width of a conductor of stator windings and having a channel height greater than or equal to a plurality of heights of such conductors. The method also includes passing at least one of the phase leads through the insulator, bending the at least one phase lead into the channel guide, and routing the at least one phase lead to a corresponding connection position of a bridge rectifier.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic illustration of an exemplary alternator;

FIG. 2 is a perspective view of a conventional stator assembly that includes a stator core;

FIGS. 3A-3B are exemplary schematic diagrams of corresponding variations of a stator winding;

FIG. 4 is an exemplary schematic diagram of a simplified electrical circuit of an alternator;

FIG. 5 is a perspective view of an alternator, according to an exemplary embodiment;

FIG. 6 is a perspective, partially-exploded view of selected portions of an alternator, according to an exemplary embodiment;

FIG. 7 is a perspective view of selected portions of an alternator, according to an exemplary embodiment;

FIGS. 8 and 9 are respectively a perspective top view and a bottom plan view of a phase lead insulator, according to an exemplary embodiment;

FIG. 10 is a top plan view of a frame of an alternator, according to an exemplary embodiment;

FIG. 11 is a top plan view of the frame of FIG. 10, illustrating phase lead routing, according to an exemplary embodiment;

FIG. 12 is a top plan view of the frame of FIG. 10 mated with a phase lead insulator, and includes a sectional perspective view of a portion thereof; FIGS. 12A-12D are cross-sectional plan views of respective portions of the phase lead insulator of FIG. 12;

FIG. 13 is a sectional perspective view of a representative section of a phase insulator, according to an exemplary embodiment;

FIG. 14 is a sectional elevation view showing routing of two phase leads along a section of a phase insulator, according to an exemplary embodiment;

FIG. 15A is side elevation view of a retaining latch formed on a side wall of a phase lead insulator and FIG. 15B is a sectional view taken along the line A-A of FIG. 15A, according to an exemplary embodiment;

FIGS. 16A-16C are respective top, front, and side elevation views of a rectifier module, according to an exemplary embodiment;

FIGS. 17A-17C are respective top, front, and side elevation views of a rectifier module, according to an exemplary embodiment;

FIG. 18 is a top plan view of selected portions of an assembly that includes a frame, a phase lead insulator, and three rectifier modules, according to an exemplary embodiment;

FIG. 19 is a cross-sectional elevation view of a phase lead connection to a module, according to an exemplary embodiment; and

FIG. 20 is a cross-sectional partial elevation view of an end portion of an alternator, shown without a phase lead insulator, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

FIG. 1 is a schematic illustration of an exemplary alternator 1. A rotor 2 rotates about a center longitudinal axis 3 and includes a shaft 4 secured at opposite ends by bearing assemblies 5. In some embodiments, alternator 1 may include slip rings 6 mounted to shaft 4 and structured for electrically communicating with spring-loaded brushes (not shown) for electrically connecting a field coil (not shown) of rotor 2 to an external voltage that excites the field coil. In various embodiments such as those with a brushless configuration, slip rings 6 may be eliminated. Rotor 2 has a rotor body 8 that typically includes a lamination stack formed by stacking individual steel laminations, each coated with a thin layer of electrical insulation. A stator assembly 10 is concentric with center axis 3 and contains stator windings 13 that are excited by rotating magnetic fields as a result of the rotation of rotor 2. The position of rotor 2 relative to a stator allows magnetic flux to flow between rotor and stator. This induces an alternating current (AC) in stator windings 13 that is output from stator 10 by phase leads 7. Phase leads 7 are typically extensions of the ends of respective individual stator coils that together form stator windings 13. Insulated copper conductor wire may be used, where the electrical insulation is removed at termination ends of phase leads 7. A housing 9 encloses alternator 1.

FIG. 2 is a perspective view of a conventional stator assembly 10 that includes a stator core 11 having a large number of slots 12 that are open on the inner circumferential side and that are evenly spaced circumferentially. For example, stator core 11 may be formed by stacking individual annular steel laminations, each coated with a thin layer of electrical insulation. The portions of stator core 11 between adjacent slots are teeth 14. Slots 12 are typically oriented longitudinally, either parallel to a center axis of assembly 10 or skewed. Stator windings 13 are typically wound in a chosen slot pattern using continuous conductor wires that are stacked in a number of layers in a slot depth direction. In a given application, stator windings 13 may be joined together at intraphase connections 15, such as for ease of manufacturing. In the illustrated example, two sets of 3-phase stator windings are terminated at six corresponding ring terminals 16, where each terminal 16 may join two conductors 17 by being crimped or by using another connection method such as welding, soldering, etc. Generally, the use of two 3-phase windings reduces electrical noise.

As an example referencing FIGS. 1 and 2, mechanical torque applied to shaft 4 of alternator 1 generates a magnetic flux between rotor 2 and stator 10 to induce AC signals in stator windings 13. Diode based rectifier bridges or MOSFET based electronic modules rectify the AC signals to produce a DC output voltage B+. Resistive loses in the stator wires and the switching losses in the rectifier diodes or electronic modules generate heat that, left unabated, can lead to thermal stress and eventual failure of alternator 1. The disclosed embodiments reduce space required for phase lead routing to thereby allow cooling of alternator 1.

FIG. 3A is an exemplary schematic diagram of a stator winding 13 having phase A coil 18, phase B coil 19, and phase C coil 20 connected in a 3-phase wye configuration. One end of each coil 18, 19, 20 is connected in common at a neutral connection 21, and the three other respective ends of coils 18, 19, 20 are each connected to a rectifier diode pair. Specifically, phase A coil 18 is connected to the cathode of rectifier diode 22 and to the anode of rectifier diode 23, phase B coil 19 is connected to the cathode of rectifier diode 24 and to the anode of rectifier diode 25, and phase C coil 20 is connected to the cathode of rectifier diode 26 and to the anode of rectifier diode 27. The respective anodes of rectifier diodes 22, 24, 26 are commonly connected to B+ bus 28, and the respective cathodes of rectifier diodes 23, 25, 27 are commonly connected to a ground bus 29.

FIG. 3B is an exemplary schematic diagram of a stator winding 13 having phase A coil 18, phase B coil 19, and phase C coil 20 connected in a 3-phase delta configuration. One end of phase A coil 18 and one end of phase B coil 19 are connected to one another, to the cathode of rectifier diode 22, and to the anode of rectifier diode 23. The other end of phase A coil 18 and one end of phase C coil 20 are connected to one another, to the cathode of rectifier diode 26, and to the anode of rectifier diode 27. The other end of phase B coil 19 and the other end of phase C coil 20 are connected to one another, to the cathode of rectifier diode 24, and to the anode of rectifier diode 25.

The configurations of FIGS. 3A-3B are merely illustrative. Many other configurations may be utilized in a rectifying circuit of a given alternator including, for example, any number of wye and/or delta coil sets, tuned and/or matched windings, auxiliary windings, tapped coils, etc.

FIG. 4 is an exemplary schematic diagram of a simplified electrical circuit of an alternator. A rectifying bridge circuit 41 has three pairs of MOSFET devices rather than three pairs of rectifying diodes. The rotating field coil 42 of an alternator rotor generates alternating current in phases A, B, C of respective stator windings 18-20. An upper half of circuit 41 includes MOSFET devices 34, 36, 38 and a lower half of circuit 41 includes MOSFET devices 35, 37, 39. MOSFET devices 34-39 may each include a diode 40 connected between the respective source and drain thereof. Such diodes 40 are commonly referred to as anti-parallel fashion or free-wheeling diodes, and are typically. incorporated into the same package as the respective MOSFET. As with any of the rectifying circuits of FIGS. 3A-3B, the MOSFET pairs 34 and 35, 36 and 37, and 38 and 39 are respectively connected to phases A, B, C for rectifying the alternating current (AC) signals and supplying direct current (DC) to buses 28, 29. Many other devices may alternatively be utilized for rectifying the AC signals of an alternator stator. For example, press-fit diodes, JFET, BJT, IGBT, and/or other devices may be used.

FIG. 5 is a perspective view of an alternator 43, according to an exemplary embodiment. Alternator 43 includes a rotating shaft 44, a lower housing 45, an upper housing 46, a frame assembly 47, a phase lead insulator 48, and a cover 49. Frame assembly 47 provides mounting and cooling features for power electronics components typically including a voltage regulator and one or more rectifier modules 52. The DC outputs of the rectifiers are coupled to a B+ terminal post 50 via a B+ bus bar 51. Several parts are omitted from FIG. 5 for illustration purposes.

FIG. 6 is a perspective, partially-exploded view of selected portions of alternator 43. Each of three rectifier modules 52 has a respective B+ output voltage terminal 53, and the three terminals 53 are electrically connected to B+ bus bar 51 at respective bend portions 54, 55, 56. For example, such connections may be made by crimping, welding, soldering, brazing, connectors, etc. An end portion of B+ bus bar 51 may be formed with a ring type terminal 57 that is secured to B+ terminal post 50 (FIG. 5) with nuts 58. Housing portions 45, 46 (FIG. 5) are omitted from FIG. 6 in order to illustrate the relation between frame 47 and stator core 11 having slots 12. Frame 47 has four bolt holes 59 that may each be a same radial distance from a center longitudinal axis of alternator 1, and that may each be defined by a surrounding fastening surface 60. For example, four fastening surfaces 60 may be coplanar with one another and may each be formed to receive a washer, lock washer, bolt head, nut, or other fastening object. In such a case, four axially extending fasteners such as bolts or threaded rod may be placed into bolt holes 59 so that the distal end of each fastener may be secured to a corresponding fastening surface at the other axial end of alternator 1. Such fasteners may then be tightened with a specified torque so that the alternator 43 assembly is held together by axial compression, with four compression locations each being substantially the same radial distance from center axis 3. When fastening surfaces 60, and their corresponding surfaces at the opposite axial end of the compression, are coplanar and substantially perpendicular to center axis 3, the axial length of the compressed assembly is uniform and symmetrical about the circumference.

FIG. 7 is a perspective view of selected portions of alternator 43. In an exemplary embodiment, the stator has two separate three-phase windings and the six separate coils are labeled A1, B1, C1, A2, B2, C2. Coil A1 has phase leads 61, 62, coil B1 has phase leads 63, 64, and coil C1 has phase leads 65, 66 extending axially out of stator core 11. Unitary tabs 67 may be formed to extend in an inward direction so that they are aligned with respective ones of phase leads 61-66. For example, when tabs 67 are so aligned, they may include holes 68 that receive respective phase leads 61-66 in a generally axial direction. Phase leads 61-66 are shown as being cut off only to illustrate their respective positions as they extend in a generally axial direction; an actual assembly has phase leads that further extend through support holes 68 to respective terminations at terminals of rectifier modules, described herein below. Within the interior of stator core 11, the internal windings and laminations are typically insulated. Such insulation is removed from ends of phase leads to expose copper conductors for termination thereof. Internal stator windings may have a same or different insulation compared with external phase leads. Insulated phase leads may be either wires or stamped copper strips, as appropriate. Two or more individual phase leads may be stacked and laid into a channel 70, 71. Each phase lead is insulated in its routing portion. The phase lead insulator may be formed of a glass-filled nylon (30% glass). Reducing the percentage of glass provides more flexibility, such as with a known PPS material. Electrical insulation properties are typically not critical so, in such a case, the insulation of phase leads only needs to be minimal. However, high temperature parameters of phase lead insulation are generally exceeded. Phase lead insulator 48 may include an axially outward facing surface 69 and a number of channel portions 70, 71 each including an axially extending outer wall 72 and an axially extending inner wall 73. Channel 70 has a curved portion 76 and channel 71 has a curved portion 77. Outer wall 72 may also be provided for defining a conductor routing area 74, for supporting a B+ bus, and/or for providing a structural support when attaching a cap to cover the electrical components. The lack of walls 72, 73 provides an access area 75 having exposed surface 69.

FIGS. 8 and 9 are respectively a perspective top view and a bottom plan view of phase lead insulator 48, according to an exemplary embodiment. Phase lead insulator 48 may be formed of any suitable nonconductive, high-temperature material that may be formed into a required shape, such as plastic, fiber, ceramic, composite, rubber, or other material. Conductor routing area 74 may include a flat surface 162 that extends as a planar bottom surface through channels 70, 71. Radial extensions 80 have annular outer perimeters and flat top and bottom surfaces for aligning and positioning insulator 48 and adjacent structure. For example, extensions 80 may abut a cover 49 (FIG. 5) and be keyed thereto. The perimeter of phase lead insulator 48 includes four annular indentations 163 that provide space for fastening devices (not shown) that secure cover 49 to corresponding portions of housing 9 (FIG. 1). A two-tiered, radially extending shelf has an outer portion 164 and an inner portion 165 that serve as assembly keys and that provide access for bending and routing phase leads. A flat bottom surface 166 abuts a corresponding planar surface of frame 47, providing a stable mating of frame 47 with insulator 48.

FIG. 10 is a top plan view of frame 47, according to an exemplary embodiment. Stator coil A2 has phase leads 81, 82, coil B2 has phase leads 83, 84, and coil C2 has phase leads 85, 86 extending generally axially out of stator core 11. The two 3-phase winding sets may be used as a six-phase machine. Any other number of phases (e.g., 3φ, 5φ, 12φ, etc.) and an associated configuration may be chosen for the stator windings. The locations of stator phase leads 61-66 and 81-86 are shown in relation to center axis 3 and tabs 67. For example, each phase lead 61-66, 81-86 may be approximately the same radial distance from center axis 3, or they may be oriented in an asymmetrical fashion. When phase leads 61-66 and 81-86 are the same radial distance from axis 3, they may occupy the same radial ‘ring’ as the four axial fasteners and associated hardware, namely the substantially same radial distance used by bolt holes 59 and surfaces 60. In such a case, the routing of phase leads 61-66 and 81-86 in the same radial ring used for the axial compression of alternator 1 effects a more efficient design by packaging more elements in the same space. Frame 47 includes heat sink surfaces 76, 77, 78 for mounting electric modules thereon, and tabs 79 that may be aligned with corresponding tabs 67 of phase lead insulator 48. In an alternative embodiment, frame 47 may be formed with fins and/or without tabs 79.

FIG. 11 is a top plan view of frame 47, illustrating phase lead routing, according to an exemplary embodiment. The phase leads from two coils are routed to each of three module locations corresponding to heat sinks 76-78. Stator A1 leads 61, 62 (FIG. 10) are bent to extend in a circumferential direction and may lie together as insulated wires in a group 87. Stator B1 leads 63, 64 are bent to extend in a circumferential direction and may lie together as insulated wires in a group 88. The four phase leads of groups 87, 88 are connected to three terminals of a rectifier module (described below) coupled to heat sink 78, with two phase leads being coupled to a same connector of the module. Stator C1 leads 65, 66 are bent to extend in the same circumferential direction (CCW) and lie together as a group 89. Stator C2 leads 85, 86 are bent to extend in a clockwise (CW) direction and may lie together as insulated wires in a group 90. The four phase leads of groups 89, 90 are connected to three terminals of a rectifier module coupled to heat sink 77. Stator A2 leads 81, 82 (FIG. 10) are bent to extend in a circumferential direction and may lie together as insulated wires in a group 91. Stator B2 leads 83, 84 are bent to extend in a circumferential direction and may lie together as insulated wires in a group 92. The four phase leads of groups 91, 92 are connected to three terminals of a rectifier module coupled to heat sink 76. Phase lead group 89 has a curved portion 93 that routes phase leads 65, 66 around a fastening surface 60. Phase lead group 90 has a curved portion 94 that routes phase leads 65, 66 around another fastening surface 60. The remaining portions of phase lead groups 89, 90 extend circumferentially at a substantially same radial distance from center axis 3, to individual destination bend locations where one or two individual phase leads then extend radially inward to termination (discussed below) at a rectifier module.

FIG. 12 is a top plan view of frame 47 mated with phase lead insulator 48, and includes a sectional perspective view of a portion thereof; FIGS. 12A-12D are cross-sectional plan views of respective portions of insulator 48. Phase lead insulator 48 may have tab portions 67 aligned with tab portions 143 of frame 47. A given portion of phase lead insulator 48 may not require any lateral or horizontal routing of phase leads, and an exemplary nominal cross-section of such portions is shown in FIGS. 12B and 12C, where insulator 48 defines a wall 144 that tapers or slants radially inward as it extends axially outward. FIG. 12D shows a same profile except that the wall portion 145 includes a circular bump or other protrusion 146 for aligning and securing in place phase lead insulator 48 or another structure. For example, protrusion 146 may push against an underside of a brush holder (not shown) to assure correct structural alignment and fit at a particular location. Similarly, as shown in FIG. 12A, a portion of insulator 48 may extend axially to include a wire guide 147 having an enlarged interior space 148, a securement member 149, and a keyed outer insulating wall 150. As discussed further below, wire guide 147 may receive one or more phase leads into space 148, where bends and routing may be enclosed by insulating material. Radially inward securement member 149 has two wall thicknesses, whereby surface 151 defines a lateral ledge 152 that abuts an extending part (not shown) of module 120 to thereby prevent movement of phase insulator 48. Outer wall 150 has a protrusion 153 that rests on an axially outward surface along an outer perimeter of frame 47. A channel section 154 includes respective outer and inner walls 99, 100 and retaining latches 103-106, described further below.

FIG. 13 is a sectional perspective view of a representative section of a phase insulator 48. In a given application, the illustrated channel portion may be mirrored on the other side of a chosen radius 95 identified with arrow 96. A channel 97 may have a width 98 defined between an inner wall 99 and an outer wall 100, and approximately the same as the width of phase lead conductors being routed therethrough. Phase lead holes 101, 102 may be located in the middle of channel 97 so that corresponding phase leads may be bent and directly routed entirely within channel 97. Opposed retaining latches 103, 104 and 105, 106 expand when phase leads are placed into channel 97 and snap back into a nominal retaining position when such phase lead(s) have been placed.

FIG. 14 is a sectional elevation view showing routing of two phase leads along a section of a phase insulator 48, according to an exemplary embodiment. In a given application, the phase leads may be inserted in a generally axial direction into a routing space 107 via holes 101, 102 and may then be bent to a perpendicular direction thereby forming respective bends 108, 109. During or after such bending the two phase leads are pressed against latches 105, 106 and 103, 104 until they are snapped-in, so that the phase leads are secured in a radially extending direction to thereby define respective lateral phase lead portions 110, 111 that lie flat against the bottom surface 112 of routing space 107. The phase leads are then bent to a perpendicular direction thereby forming respective bends 113, 114. Phase lead end portions 115, 116 are then routed to and terminated at an electronics module. When individual phase leads are stacked or otherwise in close proximity with one another, they are typically electrically insulated from one another by placement of an electrically insulative material (not shown) therebetween. For example, portions of individual phase leads may be coated with an insulative material such as varnish, and/or a separate material such as paper, resin, or other insulator may be formed as a blanket, sleeve, wedge, or other shape and may be placed to physically separate the copper or other conductive material of the adjacent phase leads.

FIG. 15A is side elevation view of a retaining latch 117 formed on a side wall 99 of phase lead insulator 48 and FIG. 15B is a sectional view taken along the line A-A of FIG. 15A. Latch portion 117 may be an integral axial extension of a side wall 99, 100 or may be a separate component. Latch 117 has a beveled portion 118, whereby a phase lead being inserted in a generally axially inward direction contacts bevel 118 and temporarily bends latch 117 until such phase lead has been placed into routing space 107. Latch 117 has a retaining surface 119 for axially retaining phase lead(s) in space 107. The distance between bottom surface 112 and retaining surface 119 may be chosen to be approximately the same as the cumulative height of the phase leads being retained, so that a snug and secure retention may be effected. The general structure of latch 117 may be implemented in forming any retaining latch 103-106 or in forming any other retention structure of phase lead insulator 48.

FIGS. 16A-16C are respective top, front, and side elevation views of a rectifier module 120, according to an exemplary embodiment. FIGS. 17A-17C are respective top, front, and side elevation views of a rectifier module 121, according to an exemplary embodiment. Module 120 has two phase lead input terminals 122, 123. Module 121 adds a third phase lead input terminal 124, but is otherwise the same as module 120, except for any internal electronic configuration differences. Modules 120, 121 may include any number of terminals. A base portion 125 has mounting holes 126, 127 for securing module 120, 121 to a heat sink 76-78 (FIG. 10), and has a substrate 128 typically including a heat transfer surface 129 for conducting heat out of module 120, 121. Terminals 122, 123, 124 each include a connection portion 130 for receiving and securing one or more phase leads, and a bus portion 131 for transferring electrical current between connection 130 and the electrical circuit within module 120, 121. A B+ terminal 134 has a connection portion 135 and a bus portion 136 for transferring B+ voltage. A cover portion 132 has a body 133 of a same or different material respecting base 125, with passages formed for inserting bus portions 131 therethrough. Terminals 122, 123, 124 pass through body 133 at respective passages 137, 138, 139 and are typically sealed and secured at such passages with potting compound or the like for ensuring that the conductive portions of terminals 122-124 do not move or come in contact with any other conductive surface and that passages 137-139 do not allow contaminants to enter the interior portion of module 120, 121.

Any chosen rectifier device dissipates power and must be cooled. For example, a MOSFET is typically carried on a substrate provided with metal traces to provide the electrical connections between electronic components. This MOSFET substrate transmits the heat to a heat sink portion 128 while providing electrical insulation to the device itself.

FIG. 18 is a top plan view of selected portions of an assembly that includes frame 47, phase lead insulator 48, and three rectifier modules 120. Terminals 122, 123 are shown bent back in a generally radially inward direction after attachment of respective phase leads thereto. For example, a welding tool (not shown) may crimp connection portion 130 (FIG. 16C) to an exposed conductor end of one or more phase leads, weld the connection, and bend the phase-connected terminals 122, 123 back onto module 120 to reduce the corresponding footprint. A B+ bus wire 140 joins together the B+ terminals 135 of each module 120 and extends to a termination loop 141 that is subsequently attached to B+ output terminal 142 with a fastener (not shown).

Any connection between phase leads and rectifier modules may be made with reduced or eliminated contact resistance as a result of bonding or making unitary the corresponding structure when one or more phase leads are mated to a drain or source of a MOSFET, to an anode or cathode of a rectifier diode, and/or to a bus. In one exemplary embodiment, a chosen MOSFET configuration may have a plurality of heat sinks. In another exemplary embodiment, power control circuitry such as for voltage regulation, speed control, temperature control, sensor control, input/output of signals, direct control such as by closed loop algorithms, and/or for other purpose(s), may share conductive portions that include phase leads. In such a case, a crimp type terminal may be formed as a unitary part of a heat sink. A phase lead may be welded or brazed to a heat sink portion 76-78 of frame 47. A rectifier diode lead and a phase lead may be coupled at a same connector.

FIG. 19 is a cross-sectional elevation view of a phase lead connection to a module 120, according to an exemplary embodiment. Heat transfer surface 129 of module 120 abuts heat sink surface 76 of slip ring end (SRE) frame 47. A thermal interface material (TIM) or other heatsink type compound may be placed at abutting surfaces 76, 129 to facilitate increased heat transfer therebetween. Heat transfer surface 129 also abuts securement portion 149 to prevent movement of phase lead insulator 48. A phase lead 155 extends out of stator end winding 156, into routing space 148, and into connection portion 130 of terminal 122. Routing space 148 has an expanded chamber that accommodates bends of phase lead 155. Wing portions 157 of terminal 122 may be wrapped around the exposed conductor of phase lead 155 and secured thereto by crimping, welding, brazing, soldering, and/or by other processes. When all phase leads have been secured, terminal 122 and its attached phase leads may be bent in a generally inward direction so that space required for phase lead routing and terminations may be minimized, whereby a cover or other peripheral structure may occupy such space. Module 120 may be formed of an electrically non-conductive material in areas that may come in contact with a metal conductor. All such module terminals may be bent inwardly after being electrically connected, thereby optimizing use of interior space of alternator 1. Phase lead insulator 48 has an annular protruding rim 158 that acts as a radial spacer for preventing contact between a cover (not shown) and interior metal portions such as phase lead 155 and connector 122. Rim 158 may include one or more keys for indexing phase lead insulator 48 to an adjoining structure.

In the illustrated embodiments, a six-phase stator winding may be effected by using two circuits having the configuration of FIG. 4. For example, three stator coils 18-20 may be configured in a wye that is connected to six rectifier devices, by using three phase leads. Two such wye circuits require six phase leads, whereby three modules 120, each having two input terminals, may be used. The B+ outputs of each module 120 are connected to one another and to B+ terminal post 50 (FIG. 5) with B+ bus 51, and the DC ground of modules 120 are in common with frame 47. Any other configuration may alternatively be used.

FIG. 20 is a cross-sectional partial elevation view of an end portion of alternator 1, shown without a phase lead insulator. A fan 159 is mounted to shaft 4 and rotor 2. Frame 47 supports modules 120, bearing assembly 160, and stator core 11. Stator end winding 156 and a heat sink portion 161 of frame 47 are in proximity to fan 159 and may thereby be cooled by convection. A cover 49 (FIG. 5) may be secured to alternator 1 for guiding airflow, for protecting the covered structure, for preventing unwanted contact with electrical high voltage, for passing B+ terminal post 50 (FIG. 5) therethrough, and for other purposes.

The disclosed phase lead insulator contributes to the improvement of alternator efficiency: by allowing phase leads to be routed as continuous conductors, without a need to connect an intermediate conductor between stator end turns and rectifier terminals; by providing physical support to phase leads subjected to vibration and other stress/strain; and, by optimizing use of the interior space of the alternator, especially for phase lead routing between a stator and the rectifier modules 120, 121. See, e.g., Bradfield, M., “Improving Alternator Efficiency Reduces Fuel Costs,”<www.delcoremy.com/documents/high-efficiency-white-paper.aspx>. The elimination of intermediate conductor(s), efficient phase lead routing, and optimization of interior space all increase alternator efficiency.

Phase lead insulator 48 may include structure that facilitates air flow therethrough. For example, insulator 48 may be optimized by eliminating unnecessary portions and/or by contouring and tapering certain portions to accommodate flow and/or to alter flow rate, pressure, temperature in cooperation with one or more fan(s) and with adjacent structure. For example, reducing the size of phase lead insulator may allow cool air to enter with a flushing-out underneath cover 49, and proper shaping/slanting of insulator walls (FIG. 12) may result in reduction of dead air spaces. The disclosed embodiments enable more air flow at the axially outward surfaces of rectifier modules 120, 121, and provide a reduction in the recirculation of warm air. In particular, the aggregate of structural improvements allows ambient air to enter more easily and thereby flush the interior portions of alternator 1 at a low flow rate. In some embodiments, phase lead insulator 48 extends circumferentially all the way around the perimeter but, alternatively, some circumferentially extending portions of insulator 48 may be eliminated. However, inner and outer walls 99, 100 (FIG. 12), channels 70, 71, and the shapes of routing space(s) 107 (FIG. 14) provide insulated regions for efficient and safe routing of phase leads.

In an exemplary assembly, phase lead insulator 48 is placed axially so that phase leads may be inserted into tab holes 68 (FIG. 7). When insulator 48 has been fully seated onto frame 47, the phase leads are pulled and then bent to their respective routing directions. For example, phase leads may be pushed past retention tabs 67, locking the phase leads in place as tabs 67 spring back to their nominal position, and then laid into a channel 70, 71 or routed directly to a rectifier module terminal 122, 123.

In another exemplary assembly, a stator core 11 is wound so that the wire ends are placed into their “natural position.” This is the start and finish of a winding. By utilizing the natural positions, efficiency is maintained because the slots are filled. By comparison, if the wire is placed into a different location, it may be necessary to add turns to route the wire closer. It is important to maximize slot fill to maximize efficiency. Accordingly, the illustrated embodiments may be modified when the natural positions of phase leads exiting stator core 11 do not correspond to a symmetrical array such as that shown in FIG. 7. In such a case, the additional retention tabs 67 of phase lead insulator 48 may be utilized for locking phase leads into a desired routing pattern. Typically, the iron design of a given stator core 11 is set, and functional modifications are made by varying the electrical design. For example, the wire size and number of turns may be changed to accommodate a given design, but the slots and shapes of stator core 11 are usually not changed.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. An alternator, comprising:
a stator core having a plurality of phase windings each having at least one phase lead extending therefrom;
an alternator frame through which the phase leads axially extend; and
a phase lead insulator that electrically insulates the phase leads, the insulator including a channel guide having an interior width substantially equal to a width of one phase lead, the insulator including a retainer for retaining a phase lead within the channel guide.

2. The alternator of claim 1, further comprising a rectifier bridge, wherein the phase leads are unbroken as they respectively extend from the stator core through the alternator frame and connect to the rectifier bridge.

3. The alternator of claim 2, wherein at least one of the phase leads is bent to have a portion substantially parallel with a bottom of the channel guide and substantially orthogonal to a longitudinal axis of the alternator.

4. The alternator of claim 4, wherein the retainer is a latch that expands as at least one of the phase lead(s) is being placed into the channel guide and that springs back to a substantially nominal position after such placement.

5. The alternator of claim 1, wherein respective portions of a plurality of the phase leads along an outside of the alternator frame are stacked atop one another within the channel guide of the phase lead insulator.

6. The alternator of claim 5, wherein the channel guide has an interior height greater than or equal to a combined axial height of two of the phase leads axially stacked in the channel guide.

7. The alternator of claim 1, further comprising a center longitudinal axis and a plurality of fasteners that axially compress a body of the alternator when tightened, wherein the channel guide occupies substantially a same radial distance from the center axis as the fasteners.

8. The alternator of claim 1, wherein the phase lead insulator has a substantially annular perimeter having a cross-sectional profile tapered to have a smaller radius in an axially outward direction.

9. The alternator of claim 1, wherein the phase lead insulator includes a wire guide for enclosing a radially outward bending portion of at least one of the phase lead(s).

10. The alternator of claim 1, further comprising an electronics module, wherein the phase lead insulator has a radially inward projection structured for being axially retained by the electronics module.

11. A phase lead insulator for electrically insulating phase leads of an alternator, comprising:
a circumferential channel guide having an interior width substantially equal to a width of a conductor of a stator winding and having an interior height substantially equal to a cumulative height of two of the phase leads axially stacked in the channel guide; and
a retainer for retaining a conductor within the channel guide.

12. The phase lead insulator of claim 11, wherein the retainer is a latch that expands as a conductor is being placed into the channel guide and that springs back to a substantially nominal position after such placement.

13. The phase lead insulator of claim 12, wherein the latch locks at least one conductor into a fixed position.

14. A method of placing phase leads of an alternator, comprising:
providing an insulator for electrically insulating the phase leads, the insulator including a channel guide having a channel width substantially equal to a width of a conductor of a stator winding and having a channel height greater than or equal to a combined axial height of two of the phase leads axially stacked in the channel guide;
passing at least one of the phase leads through the insulator;
bending the at least one phase lead into the channel guide; and
routing the at least one phase lead to a corresponding connection position of a bridge rectifier.

15. The method of claim 14, further comprising axially stacking a plurality of the phase leads within the channel guide.

16. The method of claim 14, further comprising providing a latch for retaining the at least one phase lead within the channel guide.

17. The method of claim 16, wherein the latch expands as the at least one phase lead is being placed into the channel guide and springs back to a substantially nominal position after such placement.

18. The method of claim 16, wherein the providing of the latch includes providing a plurality of latches at respectively different heights for retaining a corresponding different number of phase leads.

19. The method of claim 14, further comprising locking the at least one phase lead into a fixed position in the channel guide.

20. The method of claim 14, wherein the at least one phase lead is a continuous, unbroken extension of one of the stator windings.
